(19) United States
(12) Patent Application Publication
(10) Pub. No.: US 2003/0172083 A1
(43) Pub. Date: Sep. 11, 2003

(54) System and method of processing passenger requests

(75) Inventors: John C. Goodwin III, Suwanee, GA (US); Michael E. Halpern, Collingswood, NJ (US)

Correspondence Address: Paul W. Martin, Intellectual Property Section, Law Department, NCR Corporatiion, 1700 South Patterson Blvd., Dayton, OH, 45479-0001, US

(73) Assignee: NCR Corporation

(21) Appl. No.: 10/093,176

(22) Filed: Mar. 7, 2002

(51) Int. Cl. G06F 17/00

(52) U.S. Cl. 707/101

(57) ABSTRACT

A system and method for processing passenger requests which encourage certain passengers to use a self-service travel terminal. The system includes an assisted-service travel terminal for collecting information about passengers and for providing a first passenger from the information who has used the assisted-service travel terminal to process previous travel requests, and a self-service travel terminal for processing future requests of the first passenger.

### BACKGROUND OF THE INVENTION

The present invention relates to self-service kiosks and more specifically to a system and method of processing passenger requests.

Kiosks provide a publicly accessible computing platform for displaying World Wide Web (web) pages and other web-delivered content from web sites. Kiosks may be located within a retailer's transaction establishment or elsewhere, such as in shopping malls. Kiosks may be easily networked to web sites using the TCP/IP protocol. Web pages from web sites may be displayed using known and available web software, such as Microsoft® Internet Explorer software.

Passengers wish to reduce time they spend in lines waiting to get boarding passes, get seat assignments, or process changes in route. Lines get longer as departure times get closer.

Therefore, it would be desirable to provide a system and method of processing passenger requests that reduces the length of full-service check-in lines.

### SUMMARY OF THE INVENTION

In accordance with the teachings of the present invention, a system and method of processing passenger requests is provided.

The system includes an assisted-service travel terminal for collecting information about passengers and for providing a first passenger from the information who has used the assisted-service travel terminal to process previous travel requests, and a self-service travel terminal for processing future requests of the first passenger.

It is accordingly an object of the present invention to provide a system and method of processing passenger requests.

It is another object of the present invention to reduce the length of lines at ticket and check-in counters.

It is another object of the present invention to enable processing of passenger requests at a self-service kiosk.

It is another object of the present invention to provide a self-service kiosk which processes passenger requests.

### BRIEF DESCRIPTIONS OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 is a block diagram of a transportation system; and

FIG. 2 is a flow diagram illustrating the method of the present invention.

### DETAILED DESCRIPTION OF THE PREFERRED EMBODIMENT

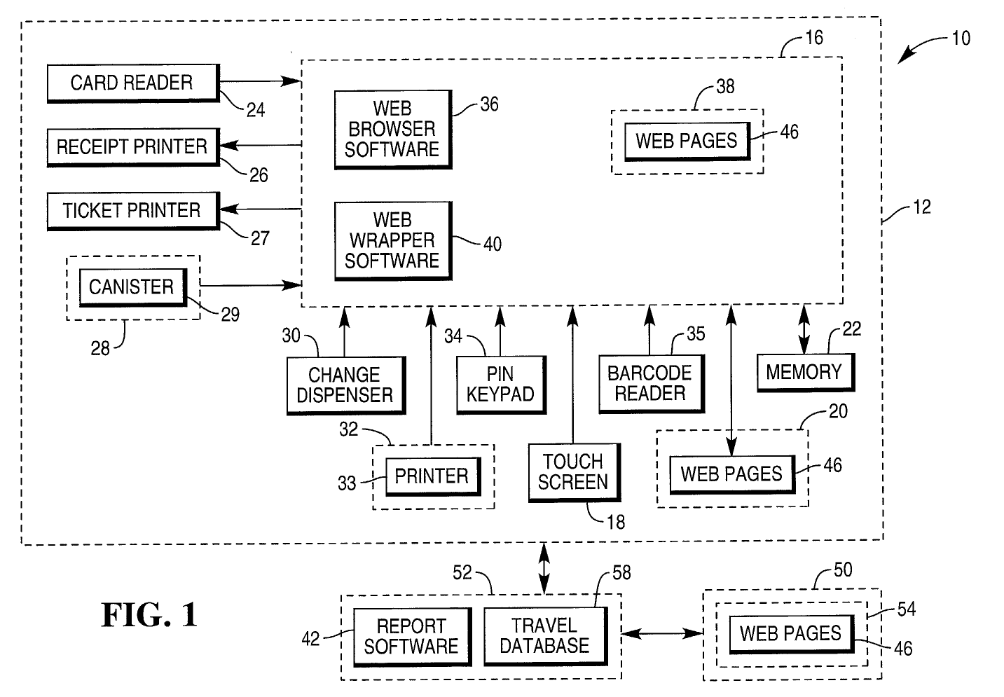

Turning now to FIG. 1, system 10 includes self-service terminal 12, assisted-service travel terminals 50, and server 52.

Self-service terminal 12 is preferably a kiosk located in a travel building, such as an airport or train station. Self-service terminal 12 may include an NCR 7401 computer.

Self-service terminal 12 primarily includes processor 16, touch screen 18, memory 22, and storage medium 20. Self-service terminal 12 may be simple and include only receipt printer 26, ticket printer 27, and card reader 24. Self-service terminal 12 may include a number of other peripherals, including printer 26, cash acceptor 28, cash dispenser 30, check reader 32, personal identification number (PIN) keypad 34, and barcode reader 35.

Processor 16 executes self-service travel application 38, which processes travel-related requests from passengers. For example, a passenger may use self-service travel application 38 to complete the check-in process, issue a boarding pass, change travel routes, or get scheduling information. Self-service travel self-service travel application 38 records passenger identification information, retrieves itinerary information from travel database 58 through server 52, displays instructions for completing check-in, records any payments due, dispenses any change due, prints boarding passes and tickets, and prints receipts. In addition, self-service travel self-service travel application 38 records and stores check-in time.

Application 38 communicates with server 52 over a network connection, such as one which uses the TCP/IP protocol. Application 38 obtains and stores travel information in travel database 58.

Processor 16 may also execute web browser software 36 and web wrapper software 40.

Web browser software 36 allows an operator to display information in a format established by the World Wide Web (WWW or “web”). Application 38 may be written as a web application which displays travel information in the form of web pages 46, although application 38 may also be a non-web application and operate without web browser software 36 and web wrapper software 40. Web pages 46 may be written using hypertext markup language (HTML) or other suitable web page language.

Web browser software 36 may include commercially available web browser software, such as Microsoft® Internet Explorer web browser software. Microsoft® Internet Explorer web browser software is configured into a kiosk operation using a “−k” command line option. This option hides toolbars and menu bars to prevent operator access to those functions.

Web browser software 36 may also display a start or “home” page within web pages 46 which operates as a default page from which kiosk operation begins and to which operation returns when an operator is finished using self-service terminal 12.

Web wrapper software 40 provides security functions. During operation, web wrapper software 40 prevents an operator from accessing kiosk files, or other applications, or the operating system software, or basic input-output system (BIOS) firmware, and prevents the operator from causing self-service terminal 12 to reboot.

Touch screen 18 records passenger selections and displays information to self-service passengers.

Storage medium 20 stores web pages 46 for use by application 38.

Memory 22 stores executed program information.

Card reader 24 reads passenger identification, credit, debit, SMART, and/or other types of cards carried by a passenger. Card reader 24 may record payment information from a passenger.

Printer 26 prints receipt information.

Printer 27 prints tickets and boarding passes.

Cash acceptor 28 includes currency storage canister 29. Cash acceptor 28 takes in currency, validates the currency, sends tendered amount information to application 38, and sends currency count information to application 38. Cash acceptor 28 may include a cash acceptor manufactured by CashCode or Mars.

Cash dispenser 30 dispenses any change due.

Check reader 32 reads checks and includes a magnetic ink character (MICR) reader. Check reader 32 also includes printer 33 for printing information on checks.

PIN keypad 34 records PIN numbers for debit card transactions.

Self-service terminal 12 may additionally include barcode reader 35, which may be used to scan barcode labels on tickets. The barcode labels contain passenger identification information.

Assisted-service travel terminals 50 execute assisted-service travel application software 54, which also processes travel-related requests, except that a travel employee controls assisted-service travel application 50 to process the requests for the passengers. Assisted-service travel application software 54 may be a web application that displays web pages 46 for processing passenger requests. Assisted-service travel terminals 50 also obtain and store travel information in travel database 58. For example, assisted-service travel terminals 50 store check-in times in travel database 58 during passenger check-in.

Other data stored by assisted-service travel terminals 50 might include number of bags, emergency contacts, a comparison between check-in time and flight time, whether kiosk check-in occurred before standard check-in time, and whether a traveler was encouraged to use self-service terminal 12.

Server 52 stores travel database 58. Server 52 executes report software 42, which identifies passengers who could benefit from using self-service terminal 12, instead of waiting in line at assisted-service travel terminals 50. For example, report software 42 may identify passengers who arrive just before departure, during a time when lines at assisted-service travel terminals 50 are long. Knowing this information, travel employees may direct these people to use self-service terminal 12. Travel employees may offer incentives through special promotions to these people. Self-service terminal 12 may deliver these promotions. Travel employees may use mail, electronic mail, announcements, electronic bulletin boards, and other communication techniques to educate travelers and deliver promotions. Assisted-service travel terminals 50 may also execute report software 42.

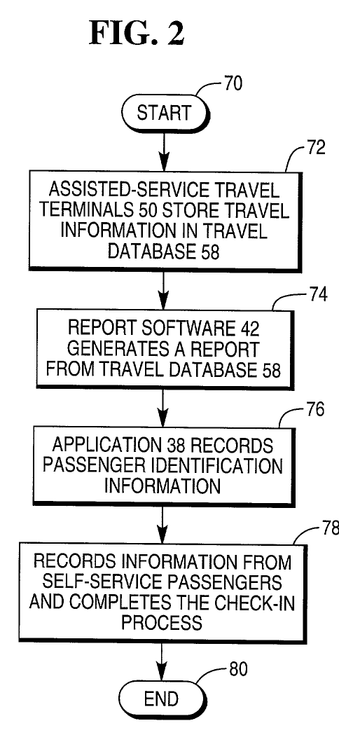

Turning now to FIG. 2, operation of system 10 is illustrated in detail beginning with START 70.

In step 72, assisted-service travel terminals 50 store travel information in travel database 58.

In step 74, report software 42 generates a report from travel database 58. Travel employees may cause report software 42 to generate this report prior to each departure. Within a predetermined time of departure, the travel employees may direct certain passengers to use self-service terminal 12.

For example, report software 42 may generate a report of all passengers scheduled for the upcoming departure who traditionally arrive just before departure. Travel employees may read the names on the report to direct these employees to use self-service terminal 12.

In step 76, application 38 records passenger identification information.

In step 78, application 38 records information from self-service passengers and completes the check-in process.

Operation ends at step 80.

Advantageously, system 10 allows travel employees to speed up passenger check-in and processing of passenger requests.

Although the present invention has been described with particular reference to certain preferred embodiments thereof, variations and modifications of the present invention can be effected within the spirit and scope of the following claims.

We claim:

1. A method of processing a passenger request comprising the steps of:
(a) storing travel information about passengers;
(b) generating a report from the travel information identifying a first passenger to encourage to use a self-service travel terminal; and
(c) recording information from the first passenger and completing the passenger request by the self-service travel terminal.

2. The method as recited in claim 1, wherein step (a) comprises the substep of:
(a-1) storing passenger identification information and passenger check-in times.

3. The method as recited in claim 1, wherein step (b) comprises the substep of:
(b-1) generating the report prior to departure.

4. The method as recited in claim 1, wherein step (b) comprises the substep of:
(b-1) generating the report identifying the first passenger as one who traditionally arrives just before departure.

5. The method as recited in claim 1, further comprising the step of:
(d) sending a mail message to the first passenger to encourage the first passenger to use the self-service travel terminal.

6. The method as recited in claim 5, wherein step (d) comprises the substep of:
(d-1) sending an electronic mail message to the first passenger.

7. The method as recited in claim 1, further comprising the step of:
(d) offering an incentive to the first passenger to use the self-service travel terminal.

8. A system for processing passenger requests comprising:
an assisted-service travel terminal for collecting information about passengers and for providing a first passenger from the information who has used the assisted-service travel terminal to process previous travel requests; and
a self-service travel terminal for processing future requests of the first passenger.

9. The system as recited in claim 8, wherein the assisted-service travel terminal identifies the first passenger prior to departure.

10. The system as recited in claim 8, wherein the assisted-service travel terminal stores passenger identification information and passenger check-in times.

11. The system as recited in claim 8, wherein the assisted-service travel terminal identifies the first passenger as one who traditionally arrives just before departure.

12. The system as recited in claim 8, further comprising:
a computer for identifying the first passenger to the assisted-service travel terminal.

13. A system for processing passenger requests comprising:
an assisted-service travel terminal for collecting information about passengers;
a computer coupled to the assisted-service travel terminal for identifying a first passenger from the information who has used the assisted-service travel terminal to process previous travel requests; and
a self-service travel terminal for processing future requests of the first passenger.

14. The system as recited in claim 13, wherein the computer identifies the first passenger prior to departure.

15. The system as recited in claim 13, wherein the assisted-service travel terminal stores passenger identification information and passenger check-in times.

16. The system as recited in claim 13, wherein the computer identifies the first passenger as one who traditionally arrives just before departure.

17. The system as recited in claim 13, wherein the computer sends a mail message to the first passenger to encourage the first passenger to use the self-service travel terminal.

18. The system as recited in claim 17, wherein the mail message comprises an electronic mail message.

19. The system as recited in claim 13, wherein the computer offers an incentive to the first passenger to use the self-service travel terminal.

20. The system as recited in claim 13, wherein the self-service travel terminal offers an incentive to the first passenger to use the self-service travel terminal.
